(19) United States
(12) Patent Application Publication
(10) Pub. No.: US 2021/0394411 A1
(43) Pub. Date: Dec. 23, 2021

(54) INJECTION MOLDING MOLD, PREFORM MOLDING METHOD, AND METHOD FOR PRODUCING HOLLOW ARTICLE

(71) Applicant: Aoki Technical Laboratory, Inc., Nagano (JP)

(72) Inventor: Hideki Takeuchi, Nagano (JP)

(21) Appl. No.: 17/071,127

(22) Filed: Oct. 15, 2020

(30) Foreign Application Priority Data
Jun. 18, 2020 (JP) 2020-105330

(51) Int. Cl. B29C 45/14; B29C 49/06

(52) U.S. Cl. CPC B29C 45/14467; B29C 2045/14524; B29C 49/06

(57) ABSTRACT

When a preform is released at an early stage from an injection molding mold, the injection cooling time is shortened before releasing the preform at an early stage from the injection molding mold to shorten the cycle time of molding the preform while the preform trunk portion is prevented from being deformed. A trunk support portion is formed on an outer end inner surface portion of a support ring molding portion in the lip mold and is configured to support a preform trunk portion at a time of releasing the preform in a non-contact manner.

### CROSS-REFERENCE TO RELATED APPLICATION

This application claims priority to Japanese Patent Application No. 2020-105330, filed Jun. 18, 2020, entitled “INJECTION MOLDING MOLD PREFORM MOLDING METHOD, AND METHOD FOR PRODUCING HOLLOW ARTICLE”, the entirety of which is incorporated herein.

### FIELD

The present invention relates to an injection molding mold for obtaining a preform from a molten resin, a preform molding method using the injection molding mold, and a method for producing a hollow article.

### BACKGROUND

Conventionally, various products have been distributed which have been produced by blow molding an injection molded preform to produce a hollow article, and filling the hollow article with a content and attaching a cap thereto. Then, as is often found in a beverage container such as a PET bottle, a support ring portion extending outward is integrally provided in a hollow article which has been produced by blow molding a preform.

For example, as illustrated in FIG. 4 of Patent Literature 1 indicated below, the support ring portion is used when the hollow articles are conveyed on a filling line of the content, or when the hollow articles are transferred.

In a beverage container or the like using a PET bottle, a cap having a tamper evidence ring is attached for the purpose of preventing tamper opening. Then, when the beverage container is opened, the tamper evidence ring is engaged with a coupler, so that the tamper evidence ring is allowed to remain on the neck portion of the container. The support ring portion also serves to receive the tamper evidence ring so that the resealed cap and the tamper evidence belt are not separated away from each other too much.

Some products have been designed to prevent tampering by capping the mouth of a container with an ordinary cap, and then covering the top surface of the cap over the support ring portion below the cap with a shrink film and shrinking the shrink film. In these products, when the opening operation is performed without removing the shrink film, the shrink film is detached from the support ring portion, so that one can visually confirm that the opening operation has been performed.

When the support ring portion is gripped with a dedicated tool for the purpose of conveying, transferring, capping, and the like on the filling line of the content, burrs tend to be generated on the lower surface of the support ring portion by sliding the dedicated tool thereunder. Patent Literature 2 shows a device as a measure against this problem where the burr is made inconspicuous by forming a step on the lower surface of the support ring portion.

As described above, the support ring portion is used at the time of conveying the hollow articles or capping, or as a portion for receiving the tamper evidence belt or catching the shrink film as described above.

However, the use applications of the support ring portion are not limited to particular ones.

### CITATION LIST

### Patent Literature

Patent Literature 1: Japanese Patent Application Laid-Open No. 2007-099381 (in particular, see FIG. 4.)

### SUMMARY

### Technical Problem

When a molten resin is injected into an injection molding mold to mold a preform and the resulting preform is blown to produce a hollow article, an injection molding mold is used although it is not limited to the production of a PET bottle. Such an injection molding mold is formed by superimposing a lip mold on an injection cavity mold and placing an injection core mold in the injection cavity mold through the lip mold.

In the injection molding mold, a support ring molding portion for molding the support ring portion may be provided at a predetermined height position inside the lip mold. Further, in order to ensure the strength of the mold, a parting line where the lip mold and the injection cavity mold are superimposed on each other is often set at the position of the support ring molding portion.

Incidentally, a technique of increasing the production efficiency of a hollow article has been adopted. The technique includes shortening the injection cooling time at the stage of molding a preform to release the preform, of which the resin is kept in a softened state at a high temperature, at an early stage from the injection molding mold. In the production of the hollow article with this technique performed, an injection molding mold in which the parting line is set at the position of the support ring molding portion may sometimes be adopted.

When a preform which is kept in a softened state at a high temperature is released at an early stage from the above-mentioned injection molding mold, the base portion of the support ring portion is easily deformed by insufficient cooling. This insufficient cooling is due to the too large wall thickness of the base portion of the support ring portion of the preform—that is, the too thick neck portion of the preform. Therefore, the following problems may occur.

When a preform 142 as illustrated in FIG. 14 is released from the injection molding mold, the injection core mold 141 is raised and removed from the inner surface of the preform 142. At the same time, the rising lip mold 143 pulls the preform 142 upward from the injection cavity mold 144. When this releasing is performed, the base portion 146 of a support ring portion 145 is rotated in the vertical direction to be deformed, so that the support ring portion 145 may sag. Further, the support ring portion 145 is deformed to sag, so that a trunk portion 147 of the preform 142 including the base portion 146 moves partially to the center side of the preform 142 to be recessed and deformed.

When the base portion 146 of the support ring portion 145 moves to the center side of the preform 142 to be recessed and deformed, the trunk portion 147 of the preform 142 is deformed to be substantially oval in a horizontal cross-sectional shape as illustrated in FIG. 15. Therefore, such a deformed trunk portion 147 is disadvantageously maintained to be in contact with the inner surface of the injection cavity mold 144 and becomes difficult to be released. In such a case, a portion of the trunk portion 147 of the preform 142, e.g., a portion serving as an accommodating body of the container, may remain inside the injection cavity mold 144.

To avoid problems caused by insufficient cooling of the base portion 146 of the support ring portion 145, it would be necessary to extend the injection cooling time. Therefore, at present, it is impossible to shorten the cycle time of molding the preform.

### Solution to Problem

In view of the above-mentioned circumstances, in order to solve the problem in which, when a preform in a state where the preform is easily deformed due to higher heat amount of the resin within an injection molding mold is released at an early stage from the injection molding mold by shortening the injection cooling time, the preform trunk portion is easily deformed, an object of the present invention is to shorten the injection cooling time before releasing the preform at an early stage from the injection molding mold to shorten the cycle time of molding the preform.

The present invention has been made in consideration of the aforementioned problems, and can provide an injection molding mold including an injection cavity mold, a lip mold to be superimposed on the injection molding mold, and an injection core mold to be placed inside the lip mold and the injection cavity mold. The injection molding mold is for use in molding a preform. This injection molding mold includes a support ring molding portion at a position corresponding to a parting line where the injection cavity mold and the lip mold are superimposed on each other, and further includes a trunk support portion configured to support a preform trunk portion at a time of releasing the preform in a non-contact manner. The trunk support portion is formed on an outer end inner surface portion of the support ring molding portion in the lip mold to protrude inward the injection molding mold. As a result, the foregoing problems can be solved. The ‘outer end inner surface portion’ corresponds to an inner surface (inner periphery) of an outer end in a radial direction of the support ring molding portion (support ring molding space) in the rip mold.

In the injection molding mold of the present invention, the trunk support portion may be provided continuously along the circumferential direction of the support ring molding portion.

Alternatively, in the injection molding mold of the present invention, the trunk support portion may be provided discontinuously along the circumferential direction of the support ring molding portion.

In the injection molding mold of the present invention, the support ring molding portion can be formed in a substantially square shape in plan view, and the trunk support portion can be positioned at corners of the support ring molding portion with the substantially square shape.

In the injection molding mold of the present invention, the trunk support portion may preferably be provided at a position along the parting line or at a position close to the parting line.

Another aspect of the present invention is to provide a method for molding a preform including filling a molten resin into any of the forgoing injection molding molds to mold a preform with a support ring portion integrally formed therewith, and releasing the preform from the injection cavity mold in a state of the trunk support portion of the lip mold receiving the support ring portion of the preform from below and supporting the preform trunk portion in a non-contact manner. As a result, the foregoing problems can be solved.

Still another aspect of the present invention is to provide a preform molded by the foregoing method for molding a preform. The preform is configured to include a recess formed at an outer end of a support ring portion by the trunk support portion of the lip mold. As a result, the foregoing problems can be solved.

Still another aspect of the present invention is to provide a method for producing a hollow article including filling a molten resin into any of the forgoing injection molding molds to mold a preform with a support ring portion integrally formed therewith, releasing the preform from the injection cavity mold in a state of the trunk support portion of the lip mold receiving the support ring portion of the preform from below and supporting the preform trunk portion in a non-contact manner, and blow molding the released preform to form a hollow article. As a result, the foregoing problems can be solved.

### Advantageous Effects of Invention

According to the injection molding mold of the present invention, the trunk support portion provided on the outer end inner surface portion of the support ring molding portion of the lip mold is disposed on a side closer to the parting line away from the inner top surface of the support ring molding portion, so that the preform to be injection molded is configured to have a jaw-shaped portion riding on the trunk support portion.

Then, when the injection core mold is extracted from the injection cavity mold and the lip mold after a required time has passed since the molten resin was filled as well as the lip mold is released from the injection cavity mold, the trunk support portion of the lip mold supports the support ring portion of the preform. Since the support ring portion is not deformed to sag downward, the base portion of the support ring portion is not deformed due to rotation or the like.

Since the support ring portion is prevented from sag downward or the base portion is prevented from being deformed in this manner, a change of flattening of the cross-section in the horizontal direction does not occur in the preform trunk portion. Furthermore, the lip mold can maintain the shape of the preform trunk portion without being in contact with the preform trunk portion while the support ring portion of the preform is interposed therebetween. Therefore, the preform trunk portion does not remain in the injection cavity mold, so that the entire preform is properly released.

According to the injection molding mold of the present invention, the trunk support portion is provided continuously along the circumferential direction of the support ring molding portion. Thus, it is possible to more reliably maintain the shape of the preform trunk portion in the circumferential direction.

Alternatively, according to the injection molding mold of the present invention, the trunk support portion is provided discontinuously along the circumferential direction of the support ring molding portion. Thus, it is possible to more reliably maintain the shape of the preform trunk portion in the circumferential direction.

According to the injection molding mold of the present invention, the support ring molding portion is formed in a substantially square shape, and the trunk support portion is configured to be positioned at the corners of the support ring molding portion. Thus, even when the support ring portion of the preform to be molded is formed in a substantially square shape in plan view, it is possible to reliably maintain the shape of the preform trunk portion in the circumferential direction.

According to the injection molding mold of the present invention, the resin thickness on the upper side of the trunk support portion is not reduced, and thus, even when the trunk support portion supports from below when releasing the preform, the resin portion riding on the trunk support portion can be prevented from being deformed.

Further, according to the method for molding a preform of the present invention, when the injection core mold is extracted from the injection cavity mold and the lip mold as well as the lip mold is released from the injection cavity mold, the trunk support portion supports the support ring portion of the preform from below. At that time, free movement in the base portion of the support ring portion is restricted, and the trunk support portion can maintain the shape of the preform trunk portion in plan view without being in contact with the preform trunk portion.

Therefore, when the preform together with the lip mold is released from the injection cavity mold, the preform trunk portion becomes properly separated from the injection cavity mold, so that releasing of the preform is properly performed. That is, in the conventional technology, a portion of the preform, of which the resin is kept in a softened state at a high temperature, is in abut contact with the inner surface of the injection cavity mold to be caught, and thereby a part of the preform trunk portion has remained in the injection cavity mold. Such a conventional problem does not arise.

According to the preform of the present invention, a portion in which the trunk support portion of the lip mold has been located is formed as a recess at the outer end of the support ring portion. Thus, since the recess is disposed at the outer end of the support ring portion, the appearance of the support ring portion is not seriously impaired.

Further, according to the method for producing a hollow article of the present invention, the preform can be released at an early stage even in a state in which the time for injection cooling the preform is shortened, so that the cycle time of molding the preform is shortened. Therefore, the production efficiency of the hollow article can be increased.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIGS. 1A and 1B illustrate an injection molding mold in an injection stretch blow molding machine according to the present invention where FIG. 1A is an explanatory view illustrating the injection molding mold in a closed state and FIG. 1B is an explanatory enlarged view illustrating a support ring molding portion;

FIG. 2 is an explanatory view illustrating a preform that is molded by means of the injection molding mold as seen from the side;

FIG. 3 is an explanatory view illustrating the same preform as seen from above;

FIG. 4 is an explanatory view illustrating a state in which the injection molding mold is filled with a resin;

FIG. 5 is an explanatory view illustrating a state in which the preform is released;

FIG. 6 is an explanatory view illustrating an example of a blow molded hollow article;

FIG. 7 is an explanatory view illustrating a lip mold in which a trunk support portion is discontinuously provided;

FIG. 8 is an explanatory view illustrating an injection molding mold configured to obtain a skirt-shaped support ring portion;

FIG. 9 is an explanatory view illustrating a preform for obtaining a skirt-shaped support ring portion, and a hollow article;

FIGS. 10A and 10B illustrate a support ring molding portion of the lip mold, where FIG. 10A is an explanatory view illustrating a state of being closed, FIG. 10B is an explanatory view illustrating a state of being opened;

FIGS. 11A and 11B illustrate the trunk support portion in a vertical cross-section, where FIG. 11A is an explanatory view illustrating a state in which the trunk support portion is positioned above the parting line and FIG. 11B is an explanatory view illustrating an example in which the trunk support portion is provided along and at the parting line position;

FIG. 12 is an explanatory view illustrating another aspect of a preform;

FIG. 13 is an explanatory view illustrating a hollow article molded from the preform of FIG. 12;

FIGS. 14A and 14B illustrate a conventional preform molding failure when released, where FIG. 14A is an explanatory view illustrating deformation of the preform trunk portion in releasing and FIG. 14B is an explanatory enlarged view illustrating a conventional support ring molding portion; and

FIG. 15 is an explanatory view showing a preform deformed in the injection cavity mold.

### DETAILED DESCRIPTION

Injection stretch blow molding machine:

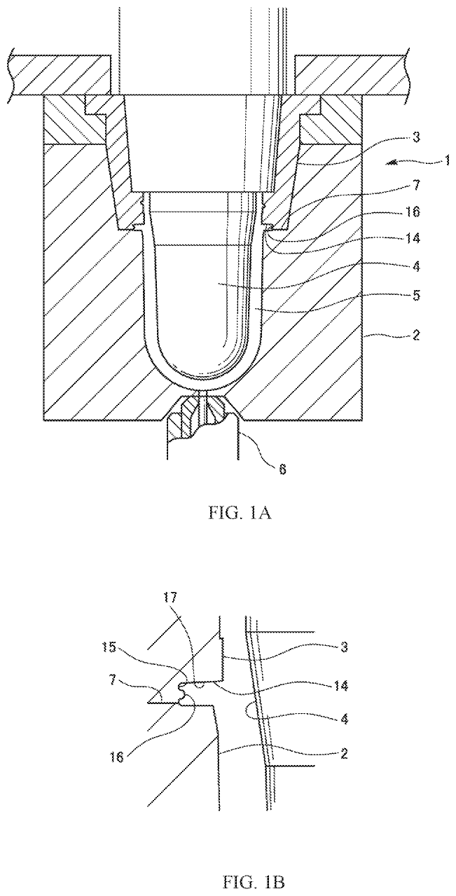

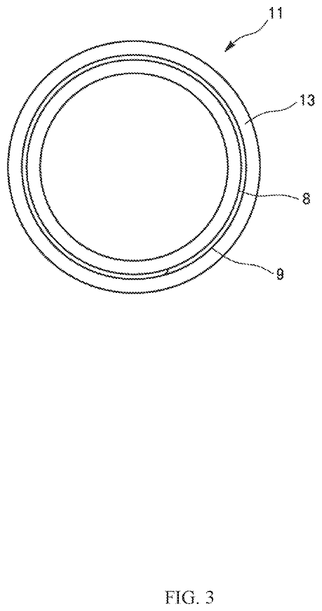

Next, the present invention will be described in detail on the basis of embodiments illustrated in FIGS. 1A to 13. An apparatus for producing a hollow article made of a synthetic resin includes an injection stretch blow molding machine in which a preform is molded using, for example, PET as a resin material, and the preform is stretched and blow molded into a hollow article. The injection stretch blow molding machine includes: an injection molding section in which a molten resin is injected from an injection apparatus to mold a preform; a blow molding section in which the preform transferred from the injection molding section is stretched and blown to form a hollow article; and a ejection section in which the hollow article transferred from the blow molding section is sent out of the apparatus.

FIGS. 1A and 1B illustrate an injection molding mold 1 that is incorporated into the injection molding section of the injection stretch blow molding machine. The injection molding mold 1 can form a preform forming space 5 thereinside. Specifically, the preform forming space 5 is formed by superimposing a lip mold 3 on an injection cavity mold 2, and inserting an injection core mold 4 from above toward the inside of the injection cavity mold 2 through the inside of the lip mold 3 to place the injection core mold 4 therein.

The injection cavity mold 2 includes a gate at its lower portion (bottom), where a runner nozzle 6 of a hot runner apparatus is disposed. A not-shown injection apparatus can inject a molten resin into the preform forming space 5 via the hot runner apparatus.

The injected molten resin in the injection molding mold 1 is cooled to complete the molding of the preform. Then, in the injection stretch blow molding machine, the injection molding mold 1 which has been closed is opened so that the preform is transferred from the injection molding section to the blow molding section in a state of being held by the lip mold 3.

The preform is stretched in the blow mold at the blow molding section while being blown with compressed air, thereby stretch blow molding the preform into a hollow article. After that, the hollow article is transferred from the blow mold to the ejection section in a state where the mouth portion of the hollow article is held by the lip mold 3. In this ejection section, the lip mold 3 is opened to release the mouth portion of the hollow article, so that the hollow article is sent out of the apparatus.

In the injection molding section, when the preform is molded in the injection molding mold 1, the injection core mold 4 is pulled up, and the preform is released at an early stage by pulling up the lip mold 3 from the injection cavity mold 2 together with the preform. As a result, the preform in a state in which a core layer of the preform (the portion sandwiched between the inner and outer skin (surface) layers of the preform) is kept at a high temperature is transferred to the blow molding section, where the preform is stretched and blow molded into the hollow article.

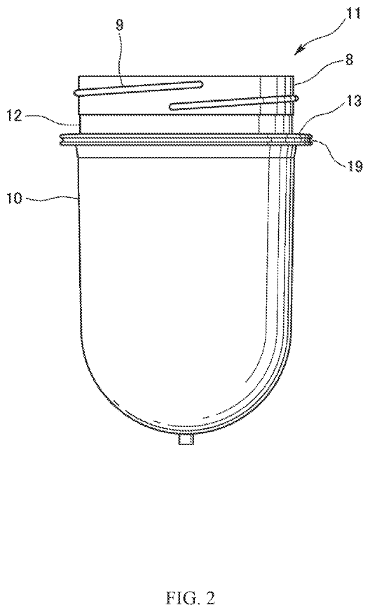

FIG. 2 illustrates a preform 11. The preform 11 includes a mouth portion 8 with an outer screw 9 formed therein, and a preform trunk portion 10 below the mouth portion 8. The preform 11 further includes a neck portion 12 connecting the upper end of the preform trunk portion 10 to the mouth portion 8, and a support ring portion 13 which projects outwardly around the neck portion 12. Accordingly, the preform 11 is configured to include a portion below the lower end of the neck portion 12 as a portion to be shaped as an accommodating portion of the hollow article.

Lip mold:

The lip mold 3 of the injection molding mold 1 configured to mold the preform 11 includes a support ring molding portion 14 (space for molding the support ring portion 13) as illustrated in FIGS. 1A and 1B. The support ring molding portion 14 is provided at a position corresponding to a parting line 7 where the injection cavity mold 2 and the lip mold 3 are superimposed on each other. The support ring molding portion 14 can function as a space for forming the support ring portion 13 of the preform 11. Note that the lip mold 3 is a mold composed of a pair of split molds that can be integrated and separated in a certain radial direction.

Trunk support portion:

As illustrated in FIGS. 1A and 1B, the support ring molding portion 14 in the lip mold 3 has an outer end inner surface portion 15 where a trunk support portion 16 is provided. The trunk support portion 16 is configured to support the preform trunk portion 10 at the time of release of the preform 11 in a non-contact manner. Then, the trunk support portion 16 is integrally provided to the lip mold 3 so as to project in a convex state toward the inside of the lip mold 3 (inside the mold). In this embodiment, the trunk support portion 16 is continuously formed along the circumferential direction of the support ring molding portion 14 with the constant vertical cross-sectional shape.

Further, the trunk support portion 16 is disposed in the lip mold 3 at a position proximate to the parting line 7 of the lip mold 3, i.e., a position proximate to the lowermost surface position. Thus, a gap is formed between the trunk support portion 16 and the top surface 17 of the support ring molding portion 14. Needless to say, the gap between the trunk support portion 16 and the top surface 17 is a space into which the molten resin properly enters at the time of injection.

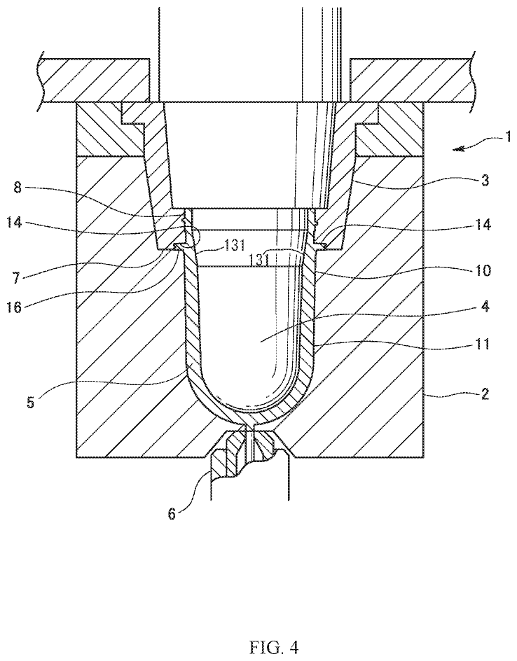

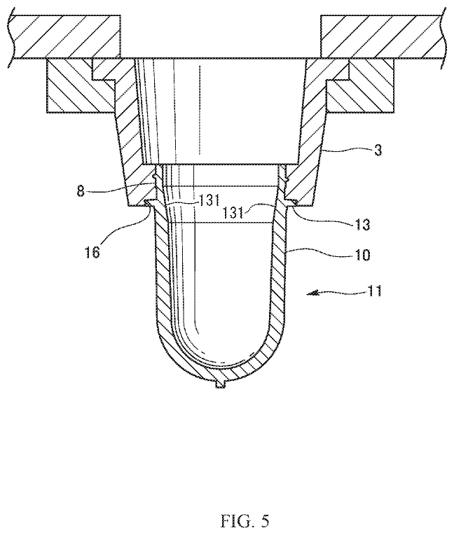

When the preform is molded with this injection molding mold 1, a molten resin is injected and the preform is released at an early stage by shortening the cooling time. FIG. 4 illustrates a state in which the molten resin is injected into the injection molding mold 1 to fill the preform forming space 5. Furthermore, FIG. 5 illustrates a state in which the injection core mold 4 is pulled up to be extracted, and the lip mold 3 together with the preform 11 is further pulled up from the injection cavity mold 2 to release the preform 11 from the injection cavity mold 2.

In a general preform including the preform 11 of the present embodiment, the preform trunk portion 10 including a base portion 131 of the support ring portion 13 as the upper end side is a portion to be shaped (stretch blow molded), and therefore, the wall thickness is large. In the case of releasing at an early stage, the inner and outer skin layers of the preform trunk portion 10, i.e., the resin layer on the inner surface side and the resin layer on the outer surface side, have a hardness capable of maintaining the shape of the preform trunk portion 10. On the other hand, the intermediate layer (core layer) between the inner and outer skin layers is softened at a high temperature to maintain a low viscosity molten state.

As described above, since the base portion 131 of the support ring portion 13 of the preform is thick, the heat amount of the intermediate layer thereof is large. Thus, when the preform is released at an early stage, heat from the intermediate layer is transmitted toward the inner and outer skin layers, and the base portion 131 becomes likely to be deformed.

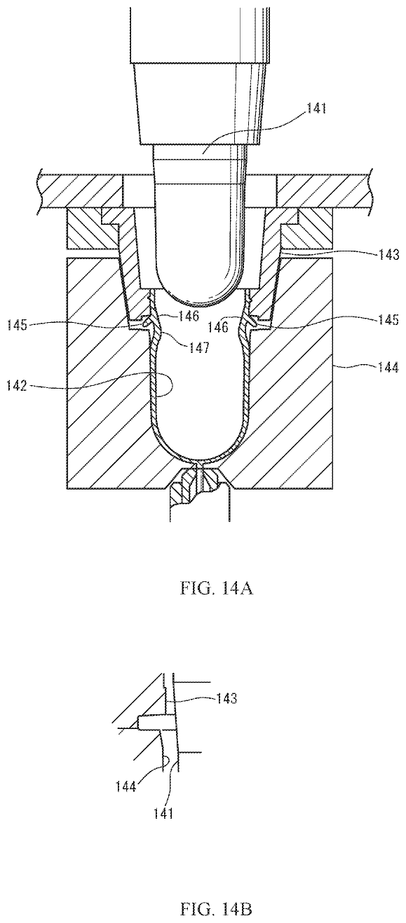

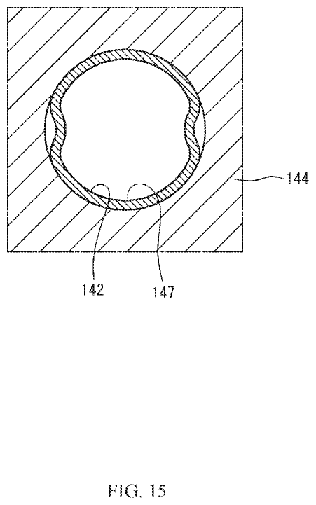

In a conventional case, with reference to FIG. 14, when the lip mold 143 is raised, the base portion 146 itself rotates in the vertical direction and deformed so that the support ring portion 145 sags. This deformation causes the preform trunk portion 147 below the support ring portion 145 to be flattened in the horizontal cross-sectional shape. Due to this, the pressing pressure of the preform trunk portion 147, which is in contact with the injection cavity mold 144, against the injection cavity mold 144 is increased, there is a problem that the preform trunk portion 147 stretches or the like to remain in the injection cavity mold 144.

In this embodiment, the trunk support portion 16 of the lip mold 3 receives the support ring portion 13 from below, so that a change such as sagging of the support ring portion 13 can be prevented, and the rotation of the base portion 131 in the vertical direction can be suppressed. That is, the trunk support portion 16 can support the preform trunk portion 10 through the support ring portion 13 in a non-contact manner so as not to deform the preform trunk portion 10. Therefore, the shape of the preform trunk portion 10 is not impaired, and the preform can be released properly. Since the support is achieved in a non-contact manner, there is no disadvantage that the support mark is attached to the inner and outer skin layers of the preform trunk portion 10.

The injection stretch blow molding machine transfers the preform 11 released at the injection molding section to the blow molding section. In this blow molding section, the preform 11 is blow molded into the hollow article 18. The obtained hollow article 18 is transferred from the blow molding section to the ejection section. As described above, the hollow article 18 is sent out of the apparatus, in the ejection section.

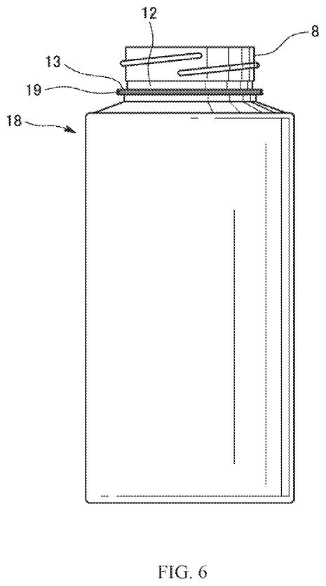

FIG. 6 illustrates a hollow article 18 thus produced. A recess 19 formed by the trunk support portion 16 of the lip mold 3 is disposed in the outer end surface of the support ring portion 13 of the hollow article 18. The recess 19 in the illustrated embodiment is a groove continuous along the circumferential direction of the support ring portion 13, and thus, does not impair the appearance of the support ring portion 13.

Discontinuous trunk support portion:

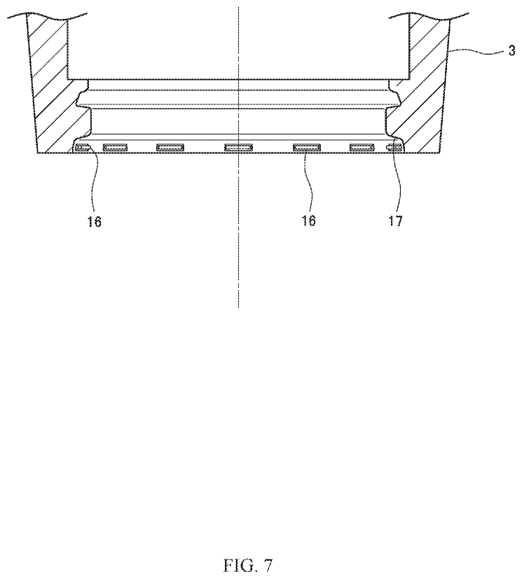

In the lip mold 3 in the foregoing embodiment, the trunk support portion 16 has been described to be continuous along the circumferential direction of the support ring molding portion 14. However, as illustrated in FIG. 7 representing another embodiment, the trunk support portion 16 may be discontinuously disposed along the circumferential direction of the support ring molding portion 14.

Skirt-shaped support ring portion:

The support ring molding portion 14 in the above-described embodiment has been described to mold the support ring portion 13 which is formed in a substantially flat plate shape and protrudes from the periphery of the neck portion 12 of the preform 11. However, the present invention is not limited to the support ring portion 13 in a flat plate shape in a vertical cross-section. The vertical cross-sectional shape of the support ring portion 13 may take shapes other than the flat plate shape as necessary.

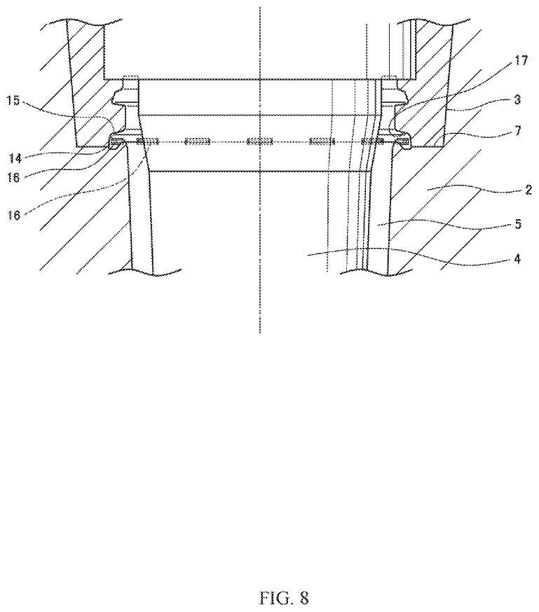

FIG. 8 illustrates a support ring molding portion 14 with the injection molding mold 1 partially illustrated in cross-section. The support ring molding portion 14 has a vertical cross-sectional shape provided with a downwardly substantially arcuate part. The vertical cross-sectional shape of the support ring molding portion 14 of the lip mold 3 is a substantially hook shape. The injection cavity mold 2 close to the support ring molding portion 14 has a shape that protrudes upward at the portion corresponding to the base end portion of the support ring portion. See FIG. 8.

The outer end inner surface portion 15 of the support ring molding portion 14 of the lip mold 3 includes the trunk support portion 16 formed discontinuously along the circumferential direction of the support ring molding portion 14 in the same manner as in the foregoing embodiment.

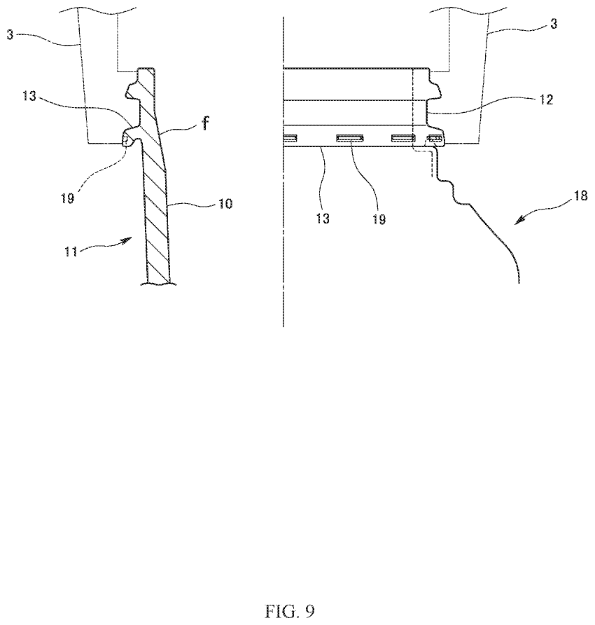

The left half of FIG. 9 illustrates a partial cross-section of the preform 11 to be molded from the injection molding mold 1 having the foregoing support ring molding portion 14. The preform 11 is formed to have a shape in which the support ring portion 13 is integrally formed around the neck portion 12 into a skirt shape by the support ring molding portion 14.

The right half of FIG. 9 illustrates a part of the hollow article 18 obtained by blow molding the preform 11 released at an early stage. The base end of the neck portion 12 is provided so as to expand in diameter at the lower surface position of the support ring portion 13. The trunk support portion 16 is formed discontinuously. Thus, recesses 19 appearing on the outer end surface of the support ring portion 13 are also formed discontinuously.

Support ring portion with flat shape:

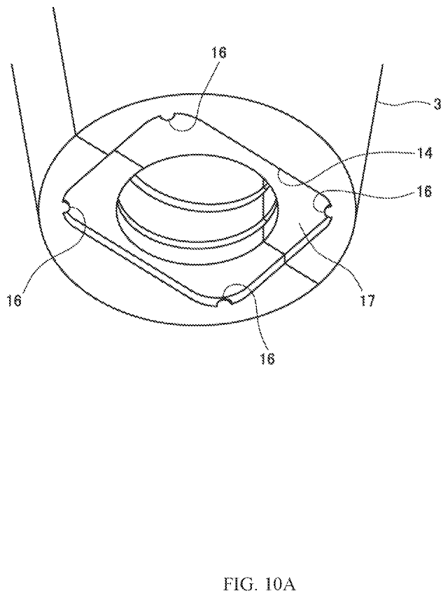

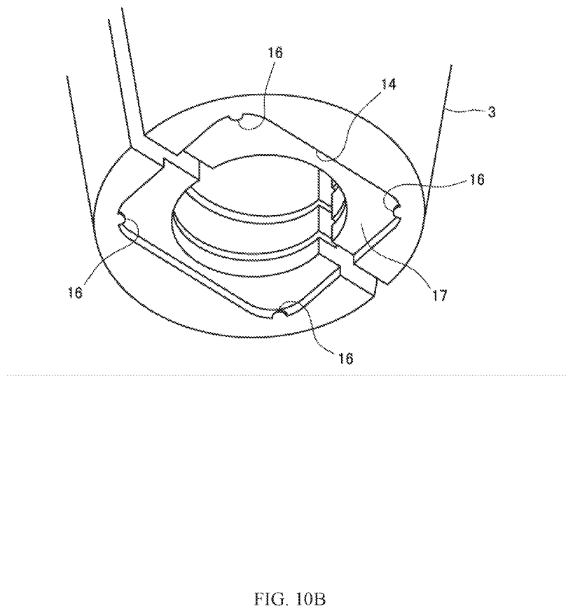

In the present invention, the planar shape of the support ring portion 13 is not limited to a circle. FIGS. 10A and 10B illustrate a lip mold 3 with a support ring molding portion 14 corresponding to a substantially rectangular support ring portion 13.

As shown in a state in which the lip mold 3 is viewed from below, in this embodiment, the support ring molding portion 14 has a substantially rectangular planar shape. The support ring molding portion 14 is formed so that a set of parallel side portions of the support ring molding portion 14 is parallel to the split direction of the lip mold 3. Trunk support portions 16 are positioned in respective four corners of the support ring molding portion 14. FIG. 10A illustrates a state in which the lip mold 3 is closed, and FIG. 10B illustrates a state in which the lip mold 3 is opened.

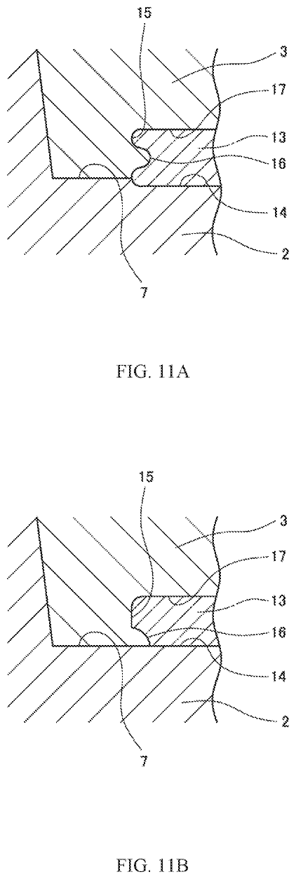

For example, when the trunk support portion 16 is designed to be set at the corners of the support ring molding portion 14 having a substantially rectangular planar shape, as illustrated in FIG. 11A representing the corners of the support ring forming portion 14 in a vertical cross-section, the trunk support portion 16 is provided at a position above the position corresponding to the parting line 7 so as to protrude toward the center of the mold as in the foregoing embodiments. Further, as shown in FIG. 11B, it is also possible to arrange the trunk support portion 16 at the position of the parting line 7 with the lower surface thereof along the position of the parting line 7.

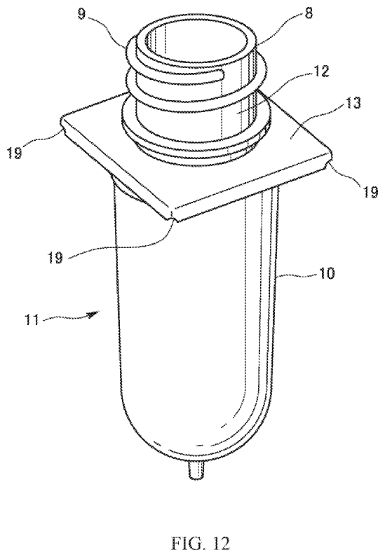

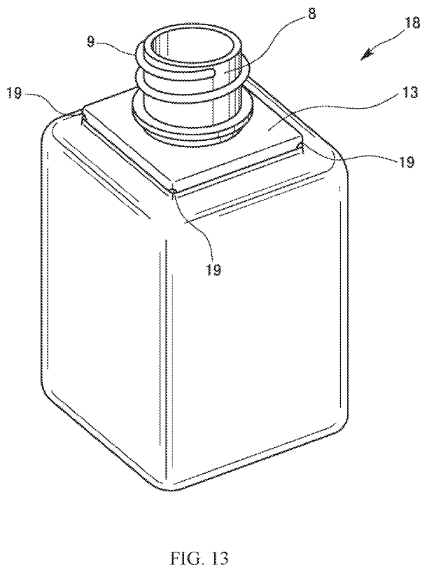

The trunk support portion 16 of the aforementioned embodiment also has a role of maintaining the shape of the preform trunk portion 10 so as not to collapse when the preform 11 with the shape illustrated in FIG. 12 is released. For the preform 11 of the embodiment illustrated in FIG. 12, the lower portion of the support ring portion 13 is designed to have a tapered shape reduced in diameter in the downward direction in order to obtain a hollow article 18 illustrated in FIG. 13. Since the preform 11 is molded by the injection molding mold to which the trunk support portion 16 is provided, the preform shape does not collapse even when the preform 11 is released at an early stage.

Although the trunk support portion 16 is disposed so that a set of side portions thereof is parallel to the split direction of the lip mold 3 in the foregoing embodiments, the trunk support portion 16 may be disposed so that the diagonal direction thereof is aligned with the split direction of the lip mold 3.

### Reference Signs List

1 injection molding mold
2 injection cavity mold
3 lip mold
4 injection core mold
5 preform forming space
7 parting line
8 preform mouth portion
10 preform trunk portion
11 preform
12 neck portion
13 support ring portion
14 support ring molding portion
15 outer end inner surface portion
16 trunk support portion
18 hollow article
19 recess
141 injection core mold
142 preform
143 lip mold
144 injection cavity mold
145 support ring portion
146 base portion
147 preform trunk portion

1. An injection molding mold for use in molding a preform, comprising:
an injection cavity mold;
a lip mold to be superimposed on the injection molding mold; and
an injection core mold to be placed inside the lip mold and the injection cavity mold,
a support ring molding portion is provided at a position corresponding to a parting line where the injection cavity mold and the lip mold are superimposed on each other, the support ring molding portion being spaced to form a support ring which projects outwardly from a neck portion of the preform, and
a trunk support portion configured to support a preform trunk portion at a time of releasing the preform in a non-contact manner is formed on an outer end inner surface portion of the support ring molding portion in the lip mold to protrude inward the injection molding mold to form a recess in an outer end surface of the support ring.

2. The injection molding mold according to claim 1, wherein the trunk support portion is provided continuously along a circumferential direction of the support ring molding portion.

3. The injection molding mold according to claim 1, wherein the trunk support portion is provided discontinuously along a circumferential direction of the support ring molding portion.

4. The injection molding mold according to claim 1, wherein the support ring molding portion is formed in a substantially square shape in plan view, and the trunk support portion is positioned at corners of the support ring molding portion with the substantially square shape.

5. The injection molding mold according to claim 1, wherein the trunk support portion is provided at any of a position along the parting line and a position close to the parting line.

6. A method for molding a preform comprising:
filling a molten resin into the injection molding mold according to claim 1 to mold a preform with a support ring portion integrally formed therewith; and
releasing the preform from the injection cavity mold in a state of the trunk support portion of the lip mold receiving the support ring portion of the preform from below and supporting the preform trunk portion in a non-contact manner.

7. A method for producing a hollow article comprising:
filling a molten resin into the injection molding mold according to claim 1 to mold a preform with a support ring portion integrally formed therewith;
releasing the preform from the injection cavity mold in a state of the trunk support portion of the lip mold receiving the support ring portion of the preform from below and supporting the preform trunk portion in a non-contact manner; and
blow molding the released preform to form a hollow article.
